(19) United States
(12) Patent Application Publication
(10) Pub. No.: US 2016/0202558 A1
(43) Pub. Date: Jul. 14, 2016

(54) CURVED LIQUID CRYSTAL DISPLAY DEVICE

(71) Applicant: Samsung Display Co., Ltd., Yongin-Si, (KR)

(72) Inventors: Jae Hong PARK, Seoul (KR); Sung-Jae YUN, Hwaseong-si (KR); Ki Chul SHIN, Seongnam-si (KR); Hyeok Jin LEE, Seongnam-si (KR)

(21) Appl. No.: 14/942,661

(22) Filed: Nov. 16, 2015

(30) Foreign Application Priority Data
Jan. 8, 2015 (KR) 10-2015-0002962

(51) Int. Cl. G02F 1/1337

(52) U.S. Cl. CPC G02F 1/133753; G02F 1/133784; G02F 2001/133757

(57) ABSTRACT

The present inventive concept relates to a curved liquid crystal display having improved transmittance, and the curved liquid crystal display according to an exemplary embodiment of the present inventive concept includes: a first substrate and a second substrate facing each other, the first substrate and the second substrate being curved to have a predetermined radius of curvature; and a liquid crystal layer interposed between the first substrate and the second substrate, wherein the liquid crystal layer includes nematic liquid crystal molecules that are continuously twisted from the first substrate to the second substrate.

### CROSS-REFERENCE TO RELATED APPLICATION

This application claims priority to and the benefit of Korean Patent Application No. 10-2015-0002962 filed in the Korean Intellectual Property Office on Jan. 8, 2015, the entire contents of which are incorporated herein by reference.

### BACKGROUND

(a) Technical Field

The present inventive concept relates to a curved liquid crystal display. More particularly, the present inventive concept relates to a curved liquid crystal display with improved transmittance.

(b) Description of the Related Art

A liquid crystal display (LCD) is one of the most widely used flat panel displays (FPD), and it is composed of two display panels on which field generating electrodes such as a pixel electrode and a common electrode are formed, and a liquid crystal layer interposed between the two display panels. A voltage is applied to the field generating electrodes to generate an electric field on the liquid crystal layer, and the orientation of liquid crystal molecules of the liquid crystal layer is determined and the polarization of incident light is controlled through the generated electric field to display an image.

Two sheets of display panels configuring the liquid crystal display may include a thin film transistor array panel and an opposing display panel. In the thin film transistor array panel, a gate line transferring a gate signal and a data line transferring a data signal are formed to cross each other, and a thin film transistor connected with the gate line and the data line, a pixel electrode connected with the thin film transistor, and the like may be formed. In the opposing display panel, a light blocking member, a color filter, a common electrode, and the like may be formed. In some cases, the light blocking member, the color filter, and the common electrode may be formed on the thin film transistor array panel.

Recently, the liquid crystal displays have been becoming wider, and curved display devices are being developed to enhance immersion of viewers.

After manufacturing the flat liquid crystal display by forming each of constituent elements in two display panels and combining two display panels, the curved liquid crystal display may be realized by bending the combined display panels through a bending process. In this case, a misalignment is generated between the two display panels, thereby the transmittance is decreased.

The above information disclosed in this Background section is only for enhancement of understanding of the background of the inventive concept and therefore it may contain information that does not form the prior art.

### SUMMARY

The present inventive concept provides a curved liquid crystal display with improved transmittance.

A curved liquid crystal display according to an exemplary embodiment of the present inventive concept includes: a first substrate and a second substrate facing each other, the first substrate and the second substrate being curved to have a predetermined radius of curvature; and a liquid crystal layer interposed between the first substrate and the second substrate, wherein the liquid crystal layer includes nematic liquid crystal molecules that are continuously twisted from the first substrate to the second substrate.

The curved liquid crystal display may be divided into a first region and a second region, and an alignment direction of the liquid crystal molecules in the first region may be different from an alignment direction of the liquid crystal molecules in the second region.

The curved liquid crystal display is divided into a first region and a second region by an imaginary line, and the imaginary line is a vertical line positioned at a center of the curved liquid crystal display.

When viewing the curved liquid crystal display in a front side, the first region may be positioned at a left side, and the second region may be positioned at a right side.

A first alignment layer disposed on the first substrate and a second alignment layer disposed on the second substrate may be further included.

A rubbing direction of the first alignment layer in the first region may be different from a rubbing direction of the first alignment layer in the second region.

A rubbing direction of the second alignment layer in the first region may be different from a rubbing direction of the second alignment layer in the second region.

The predetermined radius of curvature of the curved liquid crystal display is more than 2000 mm.

The curved liquid crystal display may include a first region and a second region, the rubbing direction of the first alignment layer in the first region may be about −135 degrees, and the rubbing direction of the second alignment layer in the first region may be about −45 degrees.

The rubbing direction of the first alignment layer in the second region may be about 45 degrees, and the rubbing direction of the second alignment layer in the second region may be about 135 degrees.

The predetermined radius of curvature of the curved liquid crystal display is more than 2000 mm.

The predetermined radius of curvature of the curved liquid crystal display is less than 2000 mm.

The curved liquid crystal display according to an exemplary embodiment of the present inventive concept may have improved transmittance.

### BRIEF DESCRIPTION OF THE DRAWINGS

FIG. 1 is a perspective view of a curved liquid crystal display according to an exemplary embodiment of the present inventive concept.

FIG. 2 is a block diagram of a curved liquid crystal display according to an exemplary embodiment of the present inventive concept.

FIG. 3 is an equivalent circuit diagram of one pixel of a liquid crystal display according to an exemplary embodiment of the present inventive concept.

FIG. 4 and FIG. 5 are cross-sectional views showing a pixel structure depending on an operation state for a liquid crystal display of a twisted nematic mode according to an exemplary embodiment of the present inventive concept.

FIG. 6 is a layout view of a curved liquid crystal display according to an exemplary embodiment of the present inventive concept.

FIG. 7 is a cross-sectional view of the curved liquid crystal display according to an exemplary embodiment of the present inventive concept of FIG. 6 taken along a line VII-VII.

FIG. 8 is a graph showing a transmittance according to a wavelength.

FIG. 9 is a graph showing a transmittance depending on an angle between a rubbing direction and a transmissive axis of a polarizer.

FIG. 10 is a graph showing a transmittance depending on a cell gap.

FIG. 11 is a view of a curved liquid crystal display according to an exemplary embodiment of the present inventive concept compared with a flat liquid crystal display.

FIG. 12 is a view showing a curved liquid crystal display according to an exemplary embodiment of the present inventive concept along with a viewer.

FIG. 13 is a view showing a rubbing direction of an alignment layer of a curved liquid crystal display according to an exemplary embodiment of the present inventive concept.

### DETAILED DESCRIPTION OF THE EMBODIMENTS

The present inventive concept will be described more fully hereinafter with reference to the accompanying drawings, in which exemplary embodiments of the inventive concept are shown. As those skilled in the art would realize, the described embodiments may be modified in various different ways, all without departing from the spirit or scope of the present inventive concept.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present between the element and the another element. In contrast, when an element is referred to as being “directly on” another element, there are no intervening elements present.

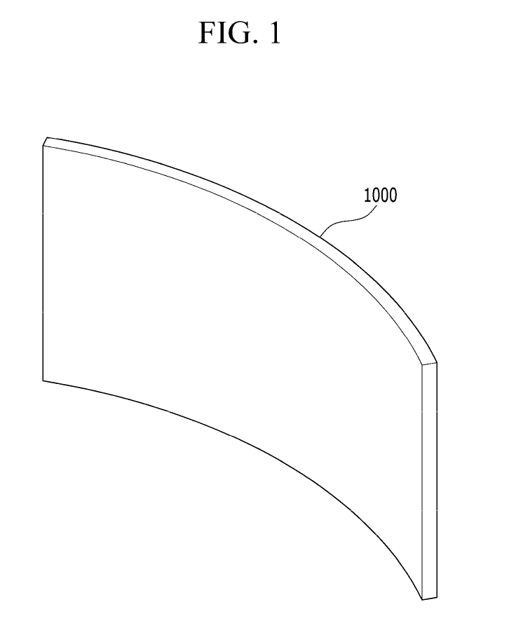

First, a curved liquid crystal display according to an exemplary embodiment of the present inventive concept will be described with reference to FIG. 1.

FIG. 1 is a perspective view of a curved liquid crystal display according to an exemplary embodiment of the present inventive concept.

As shown in FIG. 1, the curved liquid crystal display 1000 according to an exemplary embodiment of the present inventive concept is formed of a bent shape having a predetermined radius of curvature. The curved liquid crystal display 1000 is bent in a horizontal direction, however the present inventive concept is not limited thereto, and it may be bended in various directions. Also, it may be bent in two or more directions. The curved liquid crystal display 1000 according to an exemplary embodiment of the present inventive concept is formed by forming a curved surface after manufacturing the flat liquid crystal display of the flat shape.

In the case of the flat liquid crystal display, distances from eyes of the viewer to a plurality of pixels included in the display device are respectively different. For example, the distance from the eyes of the viewer to the pixel positioned at the right/left edges of the flat display device may be father than the distance from the eyes of the viewer to the center of the flat display device. In contrast, in the case of the curved liquid crystal display 1000 according to an exemplary embodiment of the present inventive concept, when the center of curvature is positioned at the eyes of the viewer, the distance from the eyes of the viewer to the plurality of pixels is almost constant. This curved liquid crystal display has a wider viewing angle such that a greater amount of information stimulates the photoreceptors in eyes of the viewer and more visual information is transmitted to the brain via the optic nerve. Because of this, reality and immersion can be further enhanced.

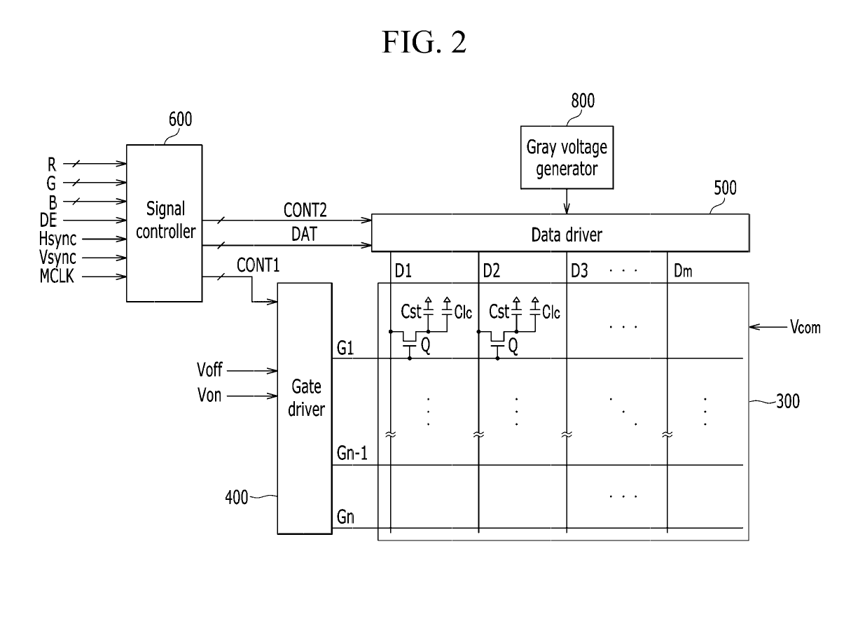

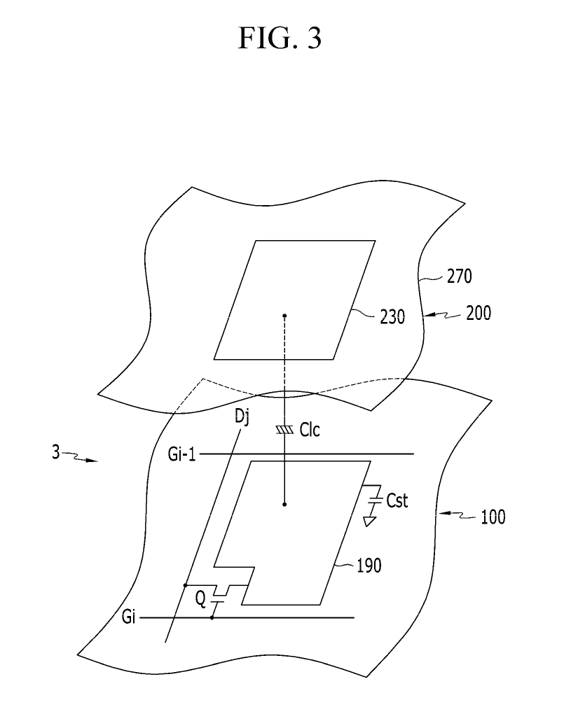

Next, the curved liquid crystal display according to an exemplary embodiment of the present inventive concept will be described with reference to FIG. 2 and FIG. 3.

FIG. 2 is a block diagram of a curved liquid crystal display according to an exemplary embodiment of the present inventive concept, and FIG. 3 is an equivalent circuit diagram of one pixel of a liquid crystal display according to an exemplary embodiment of the present inventive concept.

As shown in FIG. 2, a liquid crystal display according to an exemplary embodiment of the present inventive concept includes a liquid crystal panel assembly 300, a data driver 500 and a gate driver 400 connected to the liquid crystal panel assembly 300, a gray voltage generator 800 connected to the data driver 500, and a signal controller 600 controlling the gate driver 400 and the data driver 500.

The liquid crystal panel assembly 300 is a liquid crystal panel in which two facing display panels 100 and 200 are combined, in an equivalent circuit view, and includes a plurality of display signal lines G1-Gn and D1-Dm, and a plurality of pixels PX that are connected to the plurality of signal lines and are arranged in an approximate matrix shape.

The display signal lines G1-Gn and D1-Dm include a plurality of gate lines G1-Gn that transmit gate signals (referred to as “scanning signals”), and a plurality of data lines D1-Dm that transmit data signals. The gate lines G1-Gn extend substantially in a row direction and are substantially parallel to each other, and the data lines and D1-Dm extend substantially in a column direction and are substantially parallel to each other.

Each pixel includes a switching element Q connected to the display signal lines G1-Gn and D1-Dm, and a liquid crystal capacitor CLC and a storage capacitor CST connected thereto. The storage capacitor CST may be omitted if necessary.

The switching element Q is a three terminal element such as a thin film transistor that is provided in the lower panel 100, and a control terminal thereof is connected to the gate lines G1-Gn, an input terminal thereof is connected to the data lines D1-Dm, and an output terminal thereof is connected to the liquid crystal capacitor CLC and the storage capacitor CST.

The liquid crystal capacitor CLC includes a pixel electrode 190 on the lower panel 100, a common electrode 270 on the upper panel 200, and a liquid crystal layer 3 as a dielectric between the pixel and common electrodes 190 and 270. The pixel electrode 190 is connected to the switching element Q, and the common electrode 270 covers the entire surface of the upper panel 200 and is supplied with a common voltage Vcom.

The storage capacitor CLC is an auxiliary capacitor for the liquid crystal capacitor CLC. The storage capacitor CST includes the pixel electrode 190 and a separate signal line, which is provided on the lower panel 100, overlaps the pixel electrode 190 with an insulator interposed between the pixel electrode and the separate signal line, and is supplied with a predetermined voltage such as the common voltage Vcom. Alternatively, the storage capacitor CST includes the pixel electrode 190 and an opposing electrode which is an adjacent gate line called a previous gate line, which overlaps the pixel electrode 191 via an insulator.

For color display, each pixel uniquely represents one of primary colors (i.e., spatial division) or each pixel sequentially represents the primary colors in turn (i.e., temporal division) such that a spatial or temporal sum of the primary colors is recognized as a desired color. FIG. 3 shows an example of the spatial division in which each pixel includes a color filter 230 representing one of the primary colors of red, green, or blue in an area of the upper panel 200 facing the pixel electrode 190. Alternatively, the color filter 230 may be provided on or under the pixel electrode 190 on the lower panel 100.

At least one polarizer (not shown) for polarizing light is attached to the outer surface of at least one of the two display panels 100 and 200.

The gray voltage generator 800 generates a two sets of gray voltages (hereinafter referred to as “reference gray voltages”) related to the transmittance of the pixels. One of the two sets may have a positive value and the other may have a negative value with respect to the common voltage Vcom.

The gate driver 400 is connected to the gate lines G1-Gn of the LC panel assembly 300 and applies gate signals, which are a combination of a gate-on voltage Von and a gate-off voltage Voff, to the gate lines G1-Gn, and is generally made of a plurality of gate drivers IC.

The data driver 500 is connected to the data lines D1-Dm of the LC panel assembly 300 and selects gray voltages supplied from the gray voltage generator 800, applies the selected gray voltages to the data lines D1-Dm as data signals, and is made of a plurality of data driver ICs.

The plurality of gate driver ICs or data driver ICs may be mounted to a tape carrier package (TCP) (not shown) as a chip to be attached to the liquid crystal panel assembly 300, or may be a chip on glass (COG) mounting type in which these driver IC chips may be attached directly on the glass substrate without the TCP. On the other hand, a circuit performing a function such as the driver IC chip may be formed directly on the liquid crystal panel assembly 300 along with the thin film transistor of the pixel.

The signal controller 600 controls the operation of the gate driver 400 and the data driver 500 and is a printed circuit board (PCB).

Next, a display operation of the liquid crystal display will be described in detail.

The signal controller 600 is supplied with input image signals R, G, and B and input control signals for controlling the display thereof such as a vertical synchronization signal Vsync, a horizontal synchronization signal Hsync, a main clock signal MCLK, and a data enable signal DE from an external graphics controller (not shown). The signal controller 600 properly processes the input image signals R, G, and B depending on the operation conditions of the liquid crystal panel assembly 300 on the basis of the input image signals R, G, and B and the input control signals, and generates a gate control signal CONT1 and a data control signal CONT2. Then, the signal controller 600 transmits the gate control signal CONT1 to the gate driver 400, and transmits the data control signal CONT2 and processed image data DAT to the data driver 500.

The gate control signal CONT1 includes a vertical synchronization start signal STV for indicating the start of an output of the gate-on voltage, a gate clock signal CPV for controlling an output time of the gate-on voltage Von, and an output enable signal OE for controlling the duration of the gate-on voltage Von.

The data control signal CONT2 includes a horizontal synchronization start signal STH for indicating the start of an input of image data DAT, a load signal LOAD for instructing to apply the corresponding data voltage to the data lines D1 to Dm, an inversion signal RVS for inverting a polarity of the data voltage with respect to the common voltage Vcom (hereinafter, “the polarity of the data voltage with respect to the common voltage” is simply referred to as “the polarity of the data voltage”), a data clock signal HCLK, and so on.

The data driver 500 sequentially receives image data DAT for the pixels of one row according to the data control signal CONT2 from the signal controller 600, shifts the data, and selects a gray voltage corresponding to the image data DAT among the gray voltages from the gray voltage generator 800. Then, the image data DAT is converted into the corresponding data voltage and is applied to the corresponding one of the data lines D1 to Dm.

The gate driver 400 applies the gate-on voltage Von to the gate lines G1 to Gn according to the gate control signal CONT1 from the signal controller 600 so as to turn on the switching elements Q connected to the gate lines G1 to Gn. Then, the data voltage that is applied to the data lines D1 to Dm is applied to the corresponding pixels through the turned-on switching elements Q.

A difference between the data voltage and the common voltage Vcom that are applied to the pixel corresponds to a charging voltage of the liquid crystal capacitor Clc, that is, a pixel voltage. The alignment of liquid crystal molecules varies depending on the size of the pixel voltage, and the polarization of light that is emitted from the light source unit is changed depending on the alignment of the liquid crystal molecules when light passes through the liquid crystal layer 3. The change in polarization causes a change in transmittance of light due to the polarizer (not shown) attached to the display panels 100 and 200.

After one horizontal cycle (also referred to as “1H”) (one cycle of the horizontal synchronizing signal Hsync, the data enable signal DE, and the gate clock signal CPV) passes, the data driver 500 and the gate driver 400 repeat the same operation for the pixels of a next row. In such a manner, the gate-on voltage Von is sequentially applied to all the gate lines G1 to Gn for one frame such that the data voltage is applied to all the pixels. After one frame is ended, a next frame starts. Then, the state of the inversion signal RVS that is applied to the data driver 500 is controlled such that the polarity of a data voltage applied to each pixel is opposite to the polarity of the data voltage in the prior frame (“frame inversion”). In this case, the polarity of the data voltage on one data line may be inverted (for example, row inversion or dot inversion) or the polarity of the data voltage applied to one pixel row may vary (for example, column inversion or dot inversion) depending on the characteristics of the inversion signal RVS, even in one frame.

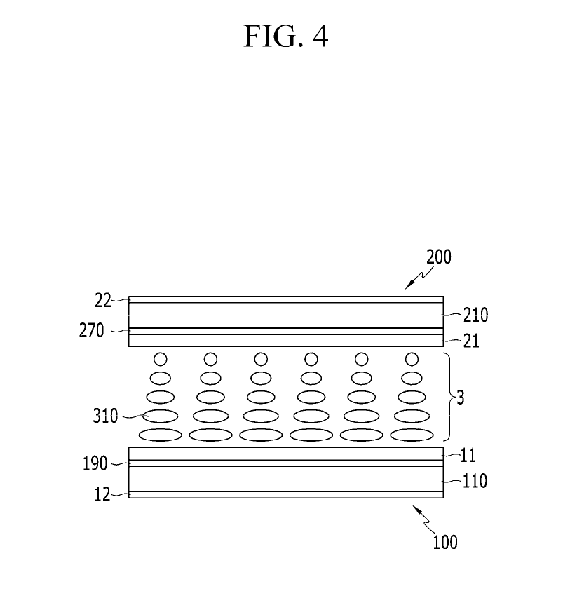

The liquid crystal molecules included in the liquid crystal layer 3 of the curved liquid crystal display according to an exemplary embodiment of the present inventive concept are a twisted nematic type, and this will be described in detail with reference to FIG. 4 and FIG. 5.

FIG. 4 and FIG. 5 are cross-sectional views showing a pixel structure of a liquid crystal display of a twisted nematic mode according to an exemplary embodiment of the present inventive concept according to an operation state.

As shown in the drawings, the liquid crystal display of the twisted nematic mode according to an exemplary embodiment of the present inventive concept includes the lower panel 100 and the upper panel 200 facing each other, the liquid crystal layer 3 formed between two display panels 100 and 200, and a first polarizer 12 and a second polarizer 22 respectively attached to outer surfaces of two display panels 100 and 200.

In this case, liquid crystal molecules 310 of the liquid crystal layer 3 are arranged to be parallel to the two display panels 100 and 200 such that the long axis direction thereof is aligned to be parallel to the two display panels 100 and 200 and gradually twisted from the first substrate 110 to the second substrate 210, thereby forming a spiral twisted structure. Here, the liquid crystal molecules 310 may be pretilted with respect to the two display panels 100 and 200.

Electrodes 190 and 270 made of a transparent or non-transparent conductive material are formed inside two display panels 100 and 200. In the case of the lower panel 100, the pixel electrode 190 is formed on the first substrate 110, in the case of the upper panel 200, the common electrode 270 is formed on the second substrate 210. The pixel electrode 190 is disposed for each unit pixel to transmit the data signal, and the common electrode 270 applies a common signal to the entire unit pixel. Each pixel electrode 190 is connected to one terminal of the switching element such as the thin film transistor formed in each pixel.

A first alignment layer 11 and a second alignment layer 21 are formed on the two electrodes 190 and 270 to align the liquid crystal molecules 310 to be parallel to the two display panels 100 and 200. The first alignment layer 11 is positioned on the first substrate 110, and the second alignment layer 21 is positioned on the second substrate 210. The first polarizer 12 and the second polarizer 22 polarizing the passing light are attached to the outer surfaces of the two display panels 100 and 200. The first polarizer 12 is attached to the outer surface of the first substrate 110, and the second polarizer 22 is attached to the outer surface of the second substrate 210.

In this case, dielectric anisotropy Δε of the liquid crystal molecules 310 of the liquid crystal layer 3 is preferably more than 0, however the dielectric anisotropy Δε may be less than 0. Also, the liquid crystal material may use all of a nematic, a chiral nematic, or a nematic liquid crystal mixed with a left-handed or right-handed chiral dopant.

Also, the first alignment layer 11 and the second alignment layer 21 may both be rubbed to have the directional characteristic when the liquid crystal molecules 310 are slanted, one of them may be selectively rubbed, and both of them may not be rubbed.

Here, the transmissive axes of the first polarizer 12 and the second polarizer 22 may be parallel or perpendicular to each other.

When an electric field is almost not formed between the two electrodes 190 and 270, as shown in FIG. 4, the liquid crystal molecules 310 of the liquid crystal layer 3 filled between the two display panels 100 and 200 are arranged such that the long axis direction thereof is aligned to be parallel to the two display panels 100 and 200 and is continuously twisted from the first substrate 110 to the second substrate 210. That is, the liquid crystal molecules 310 have the spiral twisted structure.

In this case, the polarization direction of the polarized light passing through the first polarizer 12 attached to the lower panel 100 is rotated by a retardation due to refractive anisotropy of the liquid crystal while passing through the liquid crystal layer 3. In this case, the polarization direction may be made to be rotated by 90 degrees by controlling the dielectric anisotropy, interval cell gap between the two display panels 100 and 200, or the pitch of the liquid crystal molecules 310. Here, when the transmissive axes of the two polarizers 12 and 22 are perpendicular to each other, the light passes through the second polarizer 22 attached to the upper panel 200 to realize a bright state, and this is referred to as a normally white mode. Also, when the transmissive axes of the two polarizers 12 and 22 are parallel to each other, the light passing through the first polarizer 12 of the lower panel 100 is blocked by the second polarizer 22 attached to the upper panel 200 to realize a dark state, and this is referred to as a normally black mode.

On the other hand, when applying the voltages to two electrodes 190 and 270 to form the electric field of a sufficient magnitude to drive the liquid crystal molecules 310 to the liquid crystal layer 3, as shown in FIG. 5, long axes of the liquid crystal molecules 310 are rearranged to be parallel to the direction of the electric field and to be perpendicular to the two display panels 100 and 200.

In this case, the polarization direction of the light passing through the first polarizer 12 attached to the lower panel 100 is not changed when passes through the liquid crystal layer 3. Here, if the transmissive axes of the two polarizers 12 and 22 are parallel, this light is passed through the second polarizer 22 attached to the upper panel 200, thereby realizing the bright state. If the transmissive axes of the two polarizers 12 and 22 are crossed, the light passing through the first polarizer 12 of the lower panel 100 is blocked by the second polarizer 22 of the upper panel 200, thereby realizing the dark state.

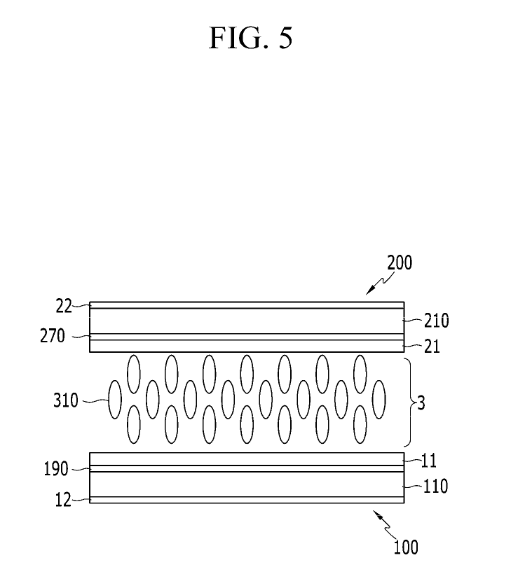

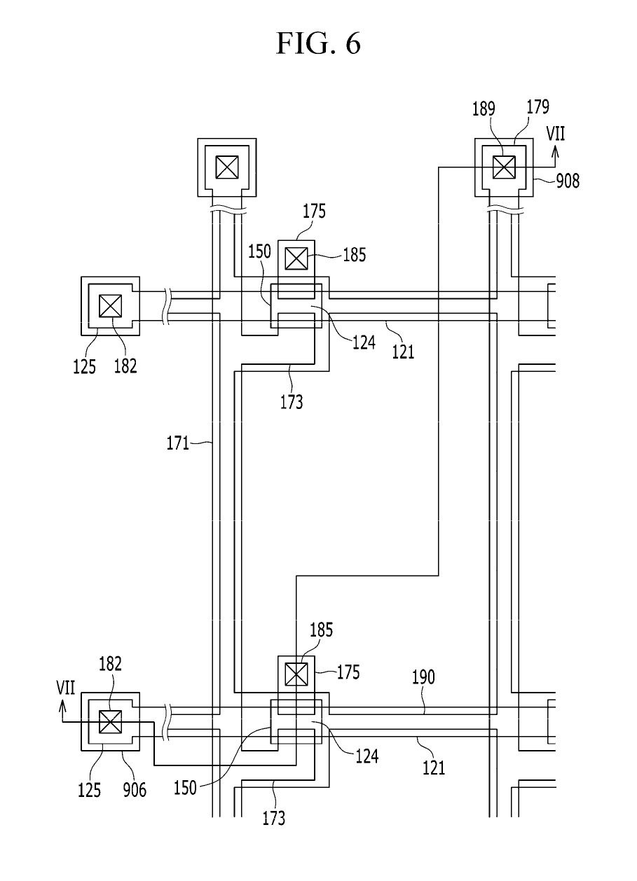

Next, the curved liquid crystal display according to an exemplary embodiment of the present inventive concept will be described with reference to FIG. 6 and FIG. 7.

FIG. 6 is a layout view of a curved liquid crystal display according to an exemplary embodiment of the present inventive concept, and FIG. 7 is a cross-sectional view of the curved liquid crystal display according to an exemplary embodiment of the present inventive concept of FIG. 6 taken along a line VII-VII.

Referring to FIG. 6 and FIG. 7, the curved liquid crystal display according to an exemplary embodiment of the present inventive concept includes a lower panel 100 and an upper panel 200 facing each other, and a liquid crystal layer 3 interposed therebetween.

First, the lower panel 100 will be described.

A plurality of gate lines 121 transmit the gate signal and mainly extend in the horizontal direction on the first substrate 110.

Each portion of the gate line 121 forms a plurality of gate electrodes 124. Also, each gate line 121 includes an expansion 125 having a wide width for connection to an external device. The gate line 121 is mainly positioned in the display area, however the expansion 125 of the gate line 121 is positioned at the peripheral area.

The gate line 121 is formed of the single layer, however two or more layers having different physical properties may be used.

A gate insulating layer 140 made of the inorganic insulating material such as a silicon oxide (SiOx) or a silicon nitride (SiNx) is formed on the gate line 121.

A plurality of semiconductors 150 made of a hydrogenated amorphous silicon (the amorphous silicon is referred to as “a-Si”) are formed on the gate insulating layer 140. The semiconductor 150 may be mainly positioned on the gate electrode 124. A plurality of ohmic contact islands 163 and 165 made of a silicide or a material such as n+ hydrogenated amorphous silicon doped with an n-type impurity at a high concentration are formed on the semiconductor 150. The ohmic contact islands are divided into two and are formed in a pair on the semiconductor.

A plurality of data lines 171 and a plurality of drain electrodes 175 are formed on the ohmic contacts 163 and 165 and the gate insulating layer 140.

The data lines 171 extending substantially in the longitudinal direction and intersect the gate lines 121, and transmit data signals. Each data line 171 includes an expansion 179 having the wide width for connection with the external device. The data line 171 is mainly positioned at the display area, however the expansion 179 of the data line 171 is positioned at the peripheral area.

A plurality of branches extending toward the drain electrode 175 from each data line 171 form source electrodes 173. A pair of a source electrode 173 and drain electrode 175 are separated from each other and positioned at opposite sides with respect to the gate electrode 124. The gate electrode 124, the source electrode 173, and the drain electrode 175 form the thin film transistor (TFT) along with the semiconductor 150, and a channel of the thin film transistor is formed in the semiconductor 150 exposed between the source electrode 173 and the drain electrode 175.

A passivation layer 180 made of the inorganic insulating material or the organic insulating material is formed on the data line 171, the drain electrode 175, and the exposed portion of the semiconductor 150.

The passivation layer 180 has a plurality of contact holes 185 and 189 respectively exposing the drain electrode 175 and the expansion 179 of the data line 171, and a plurality of contact holes 182 exposing the expansion 125 of the gate line 121 along with the gate insulating layer 140.

A plurality of pixel electrodes 190 and a plurality of contact assistants 906 and 908 are formed on the passivation layer 180. The pixel electrode 190 and the contact assistants 906 and 908 are formed of the transparent metal oxide such as ITO and IZO.

The pixel electrode 190 is physically and electrically connected to the drain electrode 175 through the contact hole 185 to receive the data voltage from the drain electrode 175.

The contact assistants 906 and 908 are connected to the expansion 125 of the gate line and the expansion 179 of the data line through the contact holes 182 and 189, respectively. The contact assistants 906 and 908 perform a function of supplementing adhesion between the extensions 125 and 179 of the gate lines 121 and the data lines 171 and the outside apparatus and protecting them. However, contact assistants 906 and 908 may be a design choice and may be omitted.

Next, the upper panel 200 will be described.

A plurality of color filters 230 and a plurality of light blocking members 220 are formed on the second substrate 210. The color filter 230 includes a red filter, a green filter, and a blue filter. However, the kind of the color filter 230 is not limited thereto, and it may be formed of magenta, yellow, cyan, and white. The light blocking member 220 may overlap the gate line 121, the data line 171, and the thin film transistor, thereby preventing light leakage.

An overcoat 250 is formed on the color filter 230 and the light blocking member 220, and a common electrode 270 is formed on the overcoat 250. The common electrode 270 is formed on the entire surface of the second substrate 210 and is made of the transparent metal oxide such as ITO and IZO.

The first alignment layer 11 and the second alignment layer 21 are respectively formed at facing surfaces of the lower panel 100 and the upper panel 200. The first alignment layer 11 may be positioned on the pixel electrode 190 in the lower panel 100, and the second alignment layer 21 may be positioned on the common electrode 270 in the upper panel 200.

If the pixel electrode 190 is applied with the data voltage and the common electrode 270 is applied with the common voltage, the electric field is generated to the two display panels 100 and 200, and the liquid crystal molecules 310 of the liquid crystal layer 3 positioned therebetween are arranged.

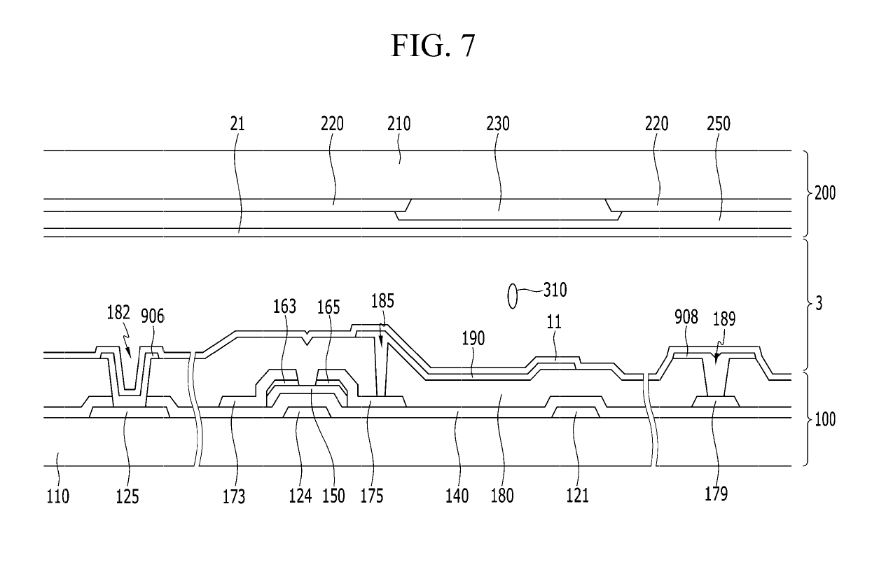

The liquid crystal layer of the curved liquid crystal display according the exemplary embodiment of the present inventive concept is made of twisted nematic liquid crystal molecules. That is, the curved liquid crystal display according to an exemplary embodiment of the present inventive concept is formed of a liquid crystal display of a twisted nematic mode. Recently, research on an electrically controlled birefringence (ECB) type of liquid crystal display such as an in plane switching mode liquid crystal display, a vertically aligned mode liquid crystal display, has been undertaken. Next, a characteristic of a twisted nematic mode liquid crystal display and the ECB type of liquid crystal display will be described with reference to FIG. 8 to FIG. 10.

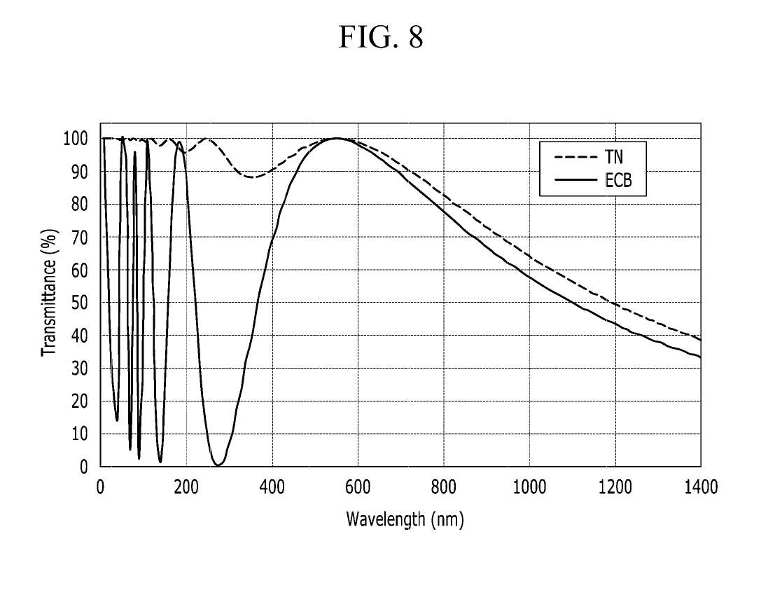

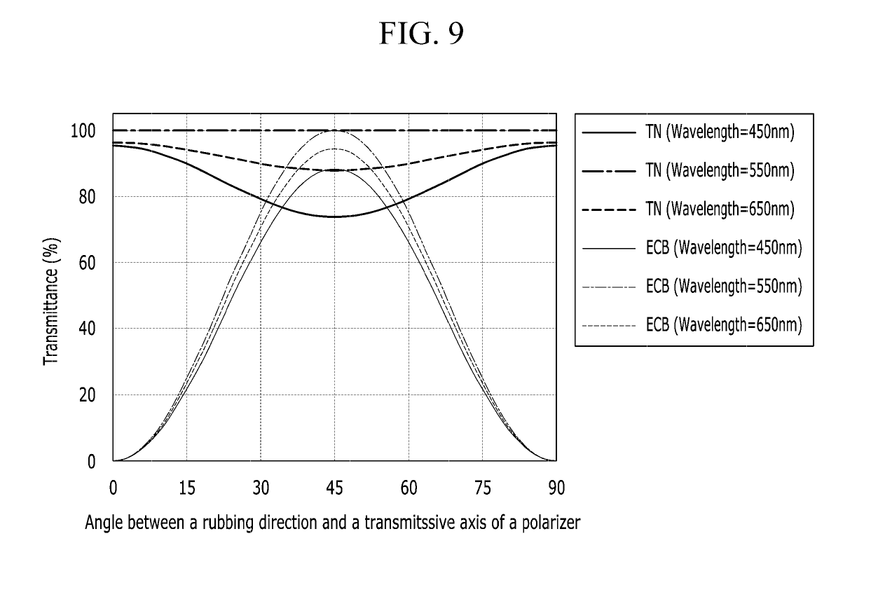

FIG. 8 is a graph showing a transmittance according to a wavelength. FIG. 9 is a graph showing a transmittance depending on an angle between a rubbing direction and a transmissive axis of a polarizer. FIG. 10 is a graph showing a transmittance depending on a cell gap. In FIG. 10, a horizontal axis and vertical axis represent relative values of the cell gap and the transmittance. The transmittance is optimized when the cell gap is 100%, and the optimized cell gap in the twisted nematic mode liquid crystal display and the optimized cell gap in the ECB type of liquid crystal display are different.

First, as shown in FIG. 8, the transmittance of each wavelength is uniform in the twisted nematic mode liquid crystal display (TN) compared with the ECB type of liquid crystal display (ECB). In the case of the ECB type of liquid crystal display, in a short wavelength and a long wavelength region, that is, in the blue and red regions in the visible light region, the transmittance is relatively low. In contrast, in the case of the liquid crystal display of the twisted nematic mode, the transmittance is similar in the entire region of the visible light. Accordingly, the liquid crystal display of the twisted nematic mode has an excellent transmittance characteristic according to a change in wavelength of light as compared with the ECB type of liquid crystal display.

As shown in FIG. 9, in the liquid crystal display (TN) of the twisted nematic mode, the highest transmittance appears when the angle between the rubbing direction and the transmissive axis of the polarizer is 0 degree and 90 degrees. Referring to each wavelength, in the case of the blue wavelength of 450 nm, the transmittance is reduced by about 20% when the angle between the rubbing direction and the transmissive axis of the polarizer is 45 degrees as compared with the transmittance when the angle is 0 degree. In the case of the green wavelength of 550 nm, the transmittance is almost constant regardless of the angle between the rubbing direction and the transmissive axis of the polarizer. In the case of the red wavelength of 650 nm, the transmittance is reduced by about 10% when the angle between the rubbing direction and the transmissive axis of the polarizer is 45 degrees as compared with the transmittance when the angle is 0 degree.

The ECB type of liquid crystal display represents the highest transmittance when the rubbing direction and the transmissive axis of the polarizer are 45 degrees. In the blue wavelength of 450 nm, the green wavelength of 550 nm, and the red wavelength of 650 nm, the transmittance is decreased to 0% when the angle between the rubbing direction and the transmissive axis of the polarizer is 0 degree or 90 degrees.

Like this, the ECB type liquid crystal display has the large loss of the transmittance when the rubbing direction and the transmissive axis of the polarizer are twisted. In contrast, the liquid crystal display of the twisted nematic mode may prevent the loss of the transmittance although the rubbing direction and the transmissive axis of the polarizer are twisted.

As shown in FIG. 10, as the cell gap is increased or decreased as compared with the optimized cell gap in the liquid crystal display of the ECB type, the transmittance is sharply decreased. In contrast, in the liquid crystal display of the twisted nematic mode, when the cell gap is deviated from the optimized cell gap, the decreasing amount of the transmittance is relatively low. When bending the display panel to form a curved liquid crystal display, the cell gap may be changed. In this case, in the liquid crystal display of the ECB type, in the region where the cell gap is changed, the transmittance is largely decreased, but in the liquid crystal display of the twisted nematic mode, the transmittance is not largely decreased.

Referring to the graphs of FIG. 8 to FIG. 10, when realizing the curved liquid crystal display through the liquid crystal display of the twisted nematic mode, the transmittance is excellent as compared with the liquid crystal display of the ECB type. That is, in the process of forming the curved liquid crystal display, even though the misalignment of the lower panel and the upper panel is occurred or the change of the cell gap is occurred, the transmittance reduction may be minimized in the liquid crystal display of the twisted nematic mode. Also, the liquid crystal display of the twisted nematic mode has excellent characteristics in price of the liquid crystal, difficulty of the process, yield, and response speed as compared with the liquid crystal display of the ECB type.

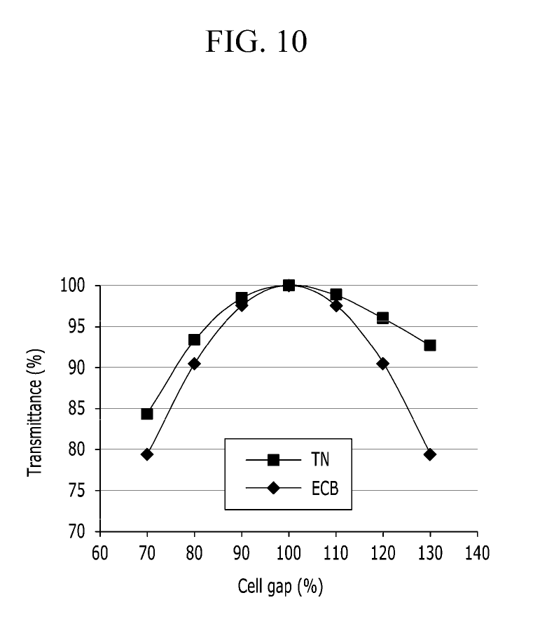

However, the liquid crystal display of the twisted nematic mode is disadvantageous in an aspect of the viewing angle as compared with the liquid crystal display of the ECB type. In the liquid crystal display of the twisted nematic mode, the screen viewing in the front side and the screen viewing in the lateral side may be different. In the curved liquid crystal display, by bending the screen, as the distance between the eyes of the viewer and each of the regions is relatively constant, these viewing angle problems may be solved. This characteristic will be described with reference to FIG. 11.

FIG. 11 is a view of a curved liquid crystal display according to an exemplary embodiment of the present inventive concept as compared with a flat liquid crystal display.

FIG. 11(a) shows the flat liquid crystal display 1000a and the viewer viewing it. In FIG. 11(a), the distance between the center of the flat liquid crystal display 1000a and the viewer is different from the distance between the edge of the flat liquid crystal display 1000a and the viewer. In this case, the viewing angle viewed at the center of the flat liquid crystal display 1000a and the viewing angle viewed at the edge are different. Accordingly, in the case of the edge, there is a problem that the visibility is decreased.

FIG. 11(b) shows the curved liquid crystal display 1000 and the viewer viewing it. In FIG. 11(b), the distance between the center of the curved liquid crystal display 1000 and the viewer is the same as the distance between the edge of the curved liquid crystal display 1000s and the viewer. In this case, the viewing angle viewed at the center of the curved liquid crystal display 1000 and the viewing angle viewed at the edge are same. Accordingly, in the case of the edge and the center, the high visibility may appear.

When a radius of curvature of the curve display is small, the viewing angle maybe improved greatly. When the radius of curvature of the curved liquid crystal display is less than about 2000 mm, the difference of the viewing angle depending on the positions of the screen is largely reduced.

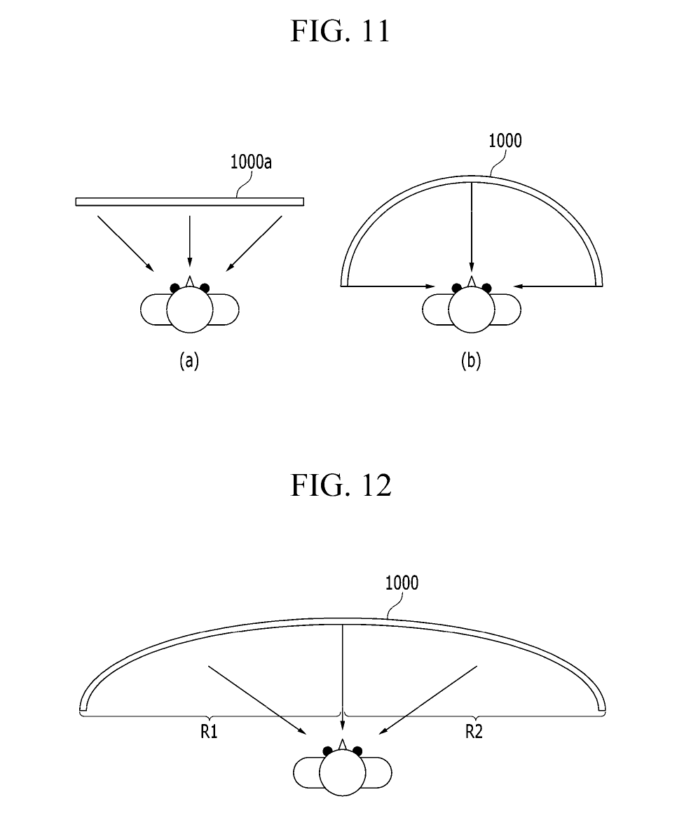

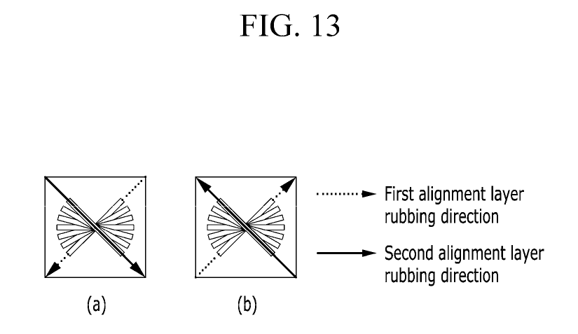

When the radius of curvature of the curved liquid crystal display is more than about 2000 mm, the viewing angle characteristic may be improved by controlling the rubbing directions of the first alignment layer and the second alignment layer. Next, the rubbing direction of the first alignment layer and the second alignment layer will be described with reference to FIG. 12 and FIG. 13.

FIG. 12 is a view showing a curved liquid crystal display according to an exemplary embodiment of the present inventive concept along with a viewer, and FIG. 13 is a view showing a rubbing direction of an alignment layer of a curved liquid crystal display according to an exemplary embodiment of the present inventive concept.

As shown in FIG. 12, the curved liquid crystal display 1000 according to an exemplary embodiment of the present inventive concept is divided into a first region R1 and a second region R2. The first region R1 and the second region R2 are divided by an imaginary line, and the imaginary line may be a line of the vertical direction positioned at the center of the curved liquid crystal display 1000. The first region R1 is positioned at the left side and the second region R2 is positioned at the right side with respect to the viewer. That is, when viewing the curved liquid crystal display 1000 in the front side, the first region R1 is positioned at the left side, and the second region R2 is positioned at the right side.

As described above, the curved liquid crystal display 1000 according to an exemplary embodiment of the present inventive concept includes a lower panel (100 of FIG. 7) and an upper panel (200 of FIG. 7), and the liquid crystal layer (3 of FIG. 7) is interposed between the lower panel and the upper panel. The first alignment layer (11 of FIG. 7) is formed in the lower panel and the second alignment layer (21 of FIG. 7) is formed in the upper panel.

The alignment direction of the liquid crystal molecules in first region R1 and the alignment direction of the liquid crystal molecules in the second region R2 are different. This may be controlled by the rubbing direction of the first alignment layer and the second alignment layer, thereby improving the viewing angle characteristic.

As shown in FIG. 13, the rubbing direction of the first alignment layer in the first region R1 is different from the rubbing direction of the first alignment layer in the second region R2, and the rubbing direction of the second alignment layer in the first region R1 is different from the rubbing direction of the second alignment layer in the second region R2. FIG. 13(a) shows the rubbing direction of the first alignment layer and the second alignment layer in the first region R1, and FIG. 13(b) shows the rubbing direction of the first alignment layer and the second alignment layer in the second region R2.

As shown in FIG. 13(a), the rubbing direction of the alignment layer in the first region R1 may be −135 degrees, and the rubbing direction of the second alignment layer may be −45 degrees. As shown in FIG. 13(b), the rubbing direction of the alignment layer in the second region R2 may be 45 degrees, and the rubbing direction of the second alignment layer may be 135 degrees.

In the curved liquid crystal display according to an exemplary embodiment of the present inventive concept, by differentiating the rubbing direction of the alignment layer in two regions, the screens having the best viewing angle characteristic in the liquid crystal display of the twisted nematic mode may be shown at both sides. That is, in the curved liquid crystal display according to an exemplary embodiment of the present inventive concept, the difference of the screen depending on the viewing angle may be minimized.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A curved liquid crystal display comprising:
a first substrate and a second substrate facing each other, the first substrate and the second substrate being curved to have a predetermined radius of curvature; and
a liquid crystal layer interposed between the first substrate and the second substrate,
wherein the liquid crystal layer includes nematic liquid crystal molecules that are continuously twisted from the first substrate to the second substrate.

2. The curved liquid crystal display of claim 1, wherein
the curved liquid crystal display is divided into a first region and a second region, and an alignment direction of the liquid crystal molecules in the first region is different from an alignment direction of the liquid crystal molecules in the second region.

3. The curved liquid crystal display of claim 2, wherein
the curved liquid crystal display is divided into a first region and a second region by an imaginary line, and the imaginary line is a vertical line positioned at a center of the curved liquid crystal display.

4. The curved liquid crystal display of claim 3, wherein
when viewing the curved liquid crystal display in a front side, the first region is positioned at a left side, and the second region is positioned at a right side.

5. The curved liquid crystal display of claim 2, further comprising:
a first alignment layer disposed on the first substrate; and
a second alignment layer disposed on the second substrate.

6. The curved liquid crystal display of claim 5, wherein
a rubbing direction of the first alignment layer in the first region is different from a rubbing direction of the first alignment layer in the second region.

7. The curved liquid crystal display of claim 6, wherein
a rubbing direction of the second alignment layer in the first region is different from a rubbing direction of the second alignment layer in the second region.

8. The curved liquid crystal display of claim 7, wherein the predetermined radius of curvature of the curved liquid crystal display is more than 2000 mm.

9. The curved liquid crystal display of claim 5, wherein
the curved liquid crystal display includes a first region and a second region,
the rubbing direction of the first alignment layer in the first region is about −135 degrees, and the rubbing direction of the second alignment layer in the first region is about −45 degrees.

10. The curved liquid crystal display of claim 9, wherein
the rubbing direction of the first alignment layer in the second region is about 45 degrees, and the rubbing direction of the second alignment layer in the second region is about 135 degrees.

11. The curved liquid crystal display of claim 10, wherein
the predetermined radius of curvature of the curved liquid crystal display is more than 2000 mm.

12. The curved liquid crystal display of claim 1, wherein
the predetermined radius of curvature of the curved liquid crystal display is less than 2000 mm.
